(19) United States
(12) Patent Application Publication
(10) Pub. No.: US 2012/0244770 A1
(43) Pub. Date: Sep. 27, 2012

(54) ANTI-SHATTER TAPE, AND METHODS OF CONSTRUCTING AND UTILIZING SAME

(76) Inventor: CHRISTOPHER S AUTTERSON, Novi, MI (US)

(21) Appl. No.: 13/239,955

(22) Filed: Sep. 22, 2011

Related U.S. Application Data
(60) Provisional application No. 61/454,899, filed on Mar. 21, 2011.

(51) Int. Cl. B32B 27/12; B32B 7/12

(52) U.S. Cl. 442/149; 428/343

(57) ABSTRACT

An Anti-Shatter Tape™ self-adhesive tape made from a strengthening face layer laminated to a pressure-sensitive adhesive layer to prevent shattering of plastic components in the interior of a vehicle when an air-bag is deployed.

### CROSS REFERENCE TO RELATED APPLICATIONS

The present application is based on and claims priority from Untied States Provisional Patent Application Ser. No. 61/454,899 filed Mar. 21, 2011.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates generally to a novel and unique Anti-Shatter Tape™ self-adhesive tape, and methods of constructing and utilizing same.

More particularly, the present invention relates to a novel and unique Anti-Shatter Tape™ self-adhesive tape to prevent fragmentation or shattering of plastic components, and methods of constructing and utilizing same.

When an automotive side-curtain air bag deploys, plastic components in the interior of the automotive vehicle may shatter and become flying projectiles which may cause injury or death to the occupants of the vehicle.

It is a desideratum of the present invention to avoid the animadversions of conventional automotive interiors.

### SUMMARY OF THE INVENTION

The present invention provides Anti-Shatter Tape™ self-adhesive tape comprising a self-adhesive fabric, plastic film, or reinforced plastic film which utilized to prevent fragmentation or shattering of plastic components.

The invention also provides an anti-shatter self-adhesive tape to prevent fragmentation or shattering of plastic components especially during an air-bag deployment, comprising: a first layer of a predetermined material to prevent fragmentation or shattering plastic components; and a second layer of high-performance pressure-sensitive adhesive laminated to said first layer to form a single-coated anti-shatter self-adhesive tape to prevent fragmentation or shattering of plastic components especially during an air-bag deployment.

The invention also provides an anti-shatter self-adhesive tape to prevent fragmentation or shattering of plastic components especially during an air-bag deployment, comprising, in combination: plastic components susceptible to fragmentation or shattering during an air-bag deployment; a first layer of a predetermined material to prevent fragmentation or shattering said plastic components; and a second layer of high-performance pressure-sensitive adhesive laminated to said first layer to form a single-coated anti-shatter self-adhesive tape to prevent fragmentation or shattering of said plastic components especially during an air-bag deployment; whereby the anti-shatter self-adhesive tape is applied to said plastic components to prevent fragmentation or shattering of said plastic components during an air-bag deployment.

The invention also provides an anti-shatter self-adhesive tape as described hereinabove, wherein said first layer comprises a woven fabric.

The invention also provides an anti-shatter self-adhesive tape as described hereinabove, wherein said first layer comprises a non-woven fabric.

The invention also provides an anti-shatter self-adhesive tape as described hereinabove, wherein said first layer comprises a plastic film.

The invention also provides an anti-shatter self-adhesive tape as described hereinabove, wherein said first layer comprises a reinforced plastic film.

The invention also provides an anti-shatter self-adhesive tape as described hereinabove wherein said first layer comprises a woven fabric made from polyester, polyethylene, or nylon.

The invention also provides an anti-shatter self-adhesive tape as described hereinabove wherein said first layer comprises a non-woven fabric made from polyester, polyethylene, or nylon.

The invention also provides an anti-shatter self-adhesive tape as described hereinabove wherein said first layer comprises a plastic film made from polyester, polyethylene, or nylon.

The invention also provides an anti-shatter self-adhesive tape as described hereinabove wherein said first layer comprises a reinforced plastic film made from polyester, polyethylene, or nylon.

The invention also provides a method of preventing fragmentation or shattering of plastic components especially during an air-bag deployment, comprising the step of placing on one or more of the plastic components an anti-shatter self-adhesive tape as described hereinabove.

It is a primary object of the present invention to provide Anti-Shatter Tape™ self-adhesive tape as described hereinabove which is used primarily in the automotive industry to prevent plastic components, such as A-pillars, from shattering upon deployment of side-curtain air bags.

Another object of the present invention is to provide a novel and unique Anti-Shatter Tape™ self-adhesive tape as described hereinabove, wherein such tape is fabricated from various fabrics, both woven and non-woven, and reinforced or plain plastic films, and methods of constructing and utilizing same.

A further object of the present invention is to provide a novel and unique Anti-Shatter Tape™ self-adhesive tape as described hereinabove, wherein such films and fabrics are typically, but not always, made from polyester, polypropylene, or nylon.

Yet another object of the present invention is to provide a novel and unique Anti-Shatter Tape™ self-adhesive tape as described hereinabove, wherein such films and fabrics have a high-performance pressure-sensitive adhesive layer laminated to them to create a single-coated tape.

Yet another object of the present invention is to provide a novel and unique Anti-Shatter Tape™ self-adhesive tape as described hereinabove, wherein the tape is strategically applied to the plastic components in the area or areas that need reinforcement.

Other objects, advantages, and features of the present invention will become apparent to those persons skilled in this particular area of technology and to other persons after having been exposed to the present patent application when read in conjunction with the accompanying patent drawings.

### BRIEF DESCRIPTION OF THE DRAWINGS

FIG. 1 is a perspective view of a first embodiment of the present invention.

FIG. 2 is a perspective view of pieces of the Anti-Shatter Tape™ self-adhesive tape affixed to a pillar of an automotive vehicle in accordance with the present invention.

FIGS. 2-6 illustrate enlarged cross-sectional views of four different embodiments of the present invention.

### DETAILED DESCRIPTION OF THE INVENTION

The following detailed description is of the best currently contemplated modes of carrying out exemplary embodiments of the invention.

The description is not to be taken in a limiting sense, but is made merely for the purpose of illustrating the general principles of the invention.

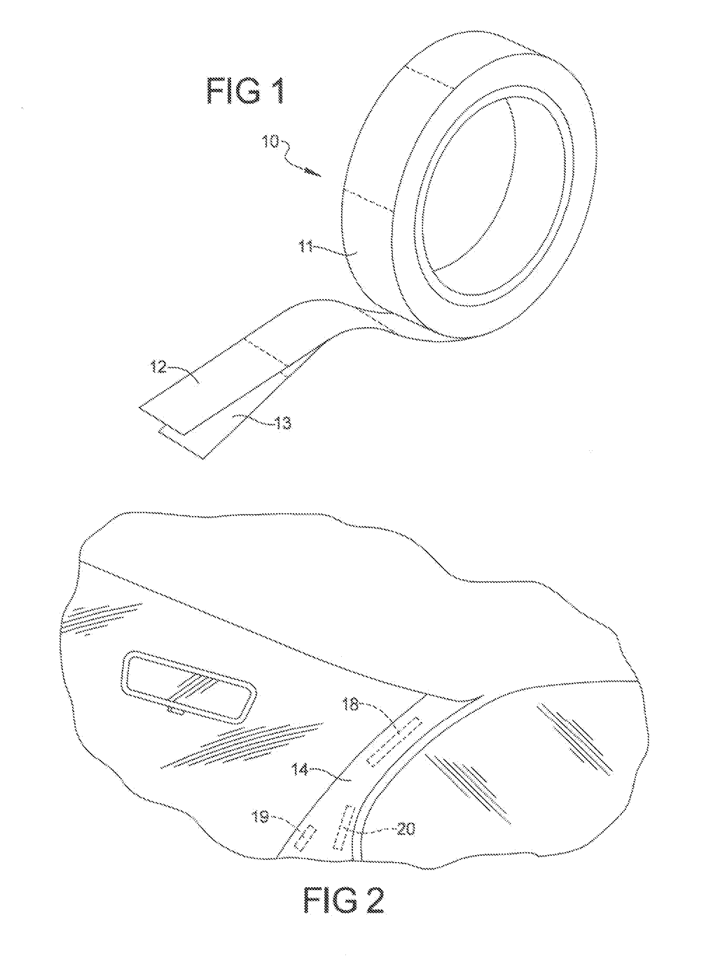

With reference to FIG. 1, there is shown a roll 10 of Anti-Shatter Tape™ self-adhesive tape 11 in accordance with a first embodiment of the present invention.

The tape 11 comprises a self-adhesive fabric, plastic film, or reinforced plastic film 12 which is utilized to prevent fragmentation or shattering of plastic components.

More particularly, the tape 11 helps prevent plastic fragmentation or shattering, and strategically contains projectiles during the deployment of air-bags.

The Anti-Shatter Tape™ self-adhesive tape 11 in accordance with the present invention may be fabricated from various fabrics, both woven and non-woven, and reinforced or plain films 12.

The aforementioned films and fabrics 12 are typically, but not always, fabricated from polyester, polyethylene, or nylon.

In accordance with the present invention, the aforementioned films and fabrics 12 have a high-performance pressure-sensitive adhesive layer 13 laminated to them to create the single coated tape 11.

The adhesive layer 13 may preferably, but not necessarily, be composed of an acrylic adhesive.

Although film 12 and adhesive layer 13 are laminated together to form a single coated tape 11, in FIG. 1 the end portion of tape 11 is shown separated merely for the purpose of illustrating the component parts 12 and 13 of the integral laminated tape 11.

The Anti-Shatter Tape™ self-adhesive tape 11 in accordance with the present invention is utilized to structurally reinforce automotive interior trim components, and is advantageously used on the automotive side curtain, pillars, glove box, instrument panel, etc.

With reference to FIG. 2, there is shown pieces 18, 19 and 20 of tape 11 strategically affixed to an automotive pillar 14.

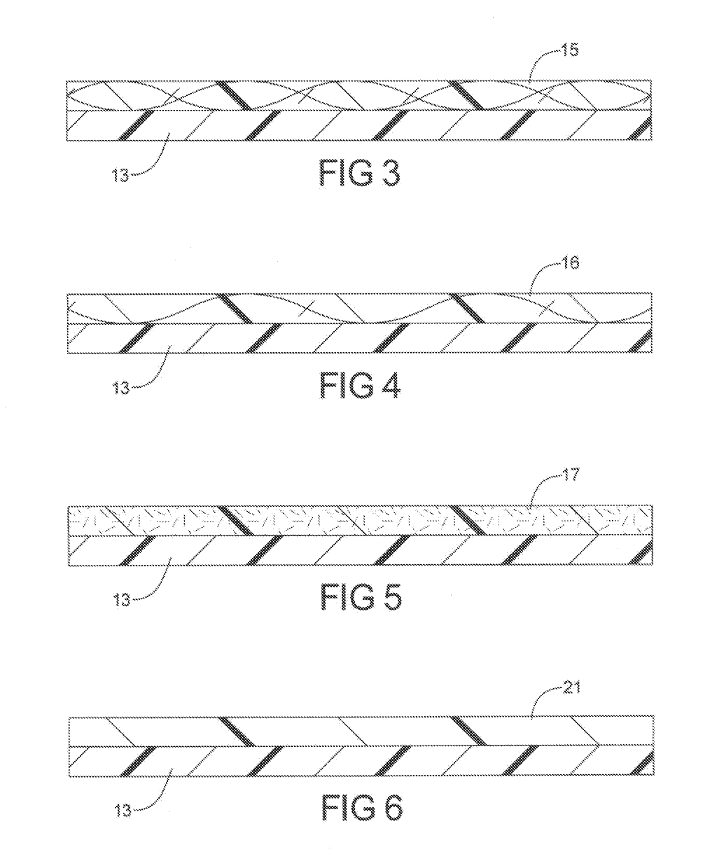

FIG. 3 illustrates that the tape 11 may comprise a doubly-reinforced plastic film 15 laminated to a high-performance pressure-sensitive adhesive layer 13.

FIG. 4 illustrates that the tape 11 may alternatively comprise a singly-reinforced plastic film 16 laminated to a high-performance pressure-sensitive adhesive layer 13.

FIG. 5 illustrates that the tape 11 may alternatively comprise a woven fabric film 17 laminated to a high-performance pressure-sensitive adhesive layer 13.

FIG. 6 illustrates that the tape 11 may alternatively comprise a plain or unreinforced film 21 laminated to a high-performance pressure-sensitive adhesive layer 13.

Pieces of the Anti-Shatter Tape™ self-adhesive tape 11 are strategically applied to the plastic components in the area or areas that require reinforcement.

For example, upon deployment of an automotive air-bag or curtain, the Anti-Shatter Tape™ self-adhesive tape 11 helps maintain the affected plastic component or components in one piece and prevents fragmentation or shattering thereof.

This is extremely important because it is necessary to prevent potential projectiles from being released during an air-bag deployment.

There have been illustrated in the accompanying drawings and described hereinabove only several possible unique and novel embodiments of the present invention which can be practiced and constructed in many different embodiments, configurations, materials, arrangements of components, sizes, and shapes.

It should be understood that many changes, modifications, variations, and other uses and applications will become apparent to those persons skilled in this particular area of technology and to others after having been exposed to the present patent specification and accompanying patent drawings.

Any and all such changes, modifications, variations and other uses and applications which do not depart from the spirit and scope of the present invention are therefore covered by and embraced within claims set forth hereinbelow,

1. An anti-shatter self-adhesive tape to prevent fragmentation or shattering of plastic components especially during an air-bag deployment, comprising:
a first layer of a predetermined material to prevent fragmentation or shattering plastic components; and
a second layer of high-performance pressure-sensitive adhesive laminated to said first layer to form a single-coated anti-shatter self-adhesive tape to prevent fragmentation or shattering of plastic components especially during an air-bag deployment.

2. An anti-shatter self-adhesive tape to prevent fragmentation or shattering of plastic components especially during an air-bag deployment according to claim 1, wherein:
said first layer comprises a woven fabric.

3. An anti-shatter self-adhesive tape to prevent fragmentation or shattering of plastic components especially during an air-bag deployment according to claim 1, wherein:
said first layer comprises a non-woven fabric.

4. An anti-shatter self-adhesive tape to prevent fragmentation or shattering of plastic components especially during an air-bag deployment according to claim 1, wherein:
said first layer comprises a plastic film.

5. An anti-shatter self-adhesive tape to prevent fragmentation or shattering of plastic components especially during an air-bag deployment according to claim 1, wherein:
said first layer comprises a reinforced plastic film.

6. An anti-shatter self-adhesive tape to prevent fragmentation or shattering of plastic components especially during an air-bag deployment according to claim 1, wherein:
said first layer comprises a woven fabric made from polyester, polyethylene, or nylon.

7. An anti-shatter self-adhesive tape to prevent fragmentation or shattering of plastic components especially during an air-bag deployment according to claim 1, wherein:
said first layer comprises a non-woven fabric made from polyester, polyethylene, or nylon.

8. An anti-shatter self-adhesive tape to prevent fragmentation or shattering of plastic components especially during an air-bag deployment according to claim 1, wherein:
said first layer comprises a plastic film made from polyester, polyethylene, or nylon.

9. An anti-shatter self-adhesive tape to prevent fragmentation or shattering of plastic components especially during an air-bag deployment according to claim 1, wherein:
said first layer comprises a reinforced plastic film made from polyester, polyethylene, or nylon.

10. A method of preventing fragmentation or shattering of plastic components especially during an air-bag deployment, comprising the step of:
placing on one or more of the plastic components an anti-shatter self-adhesive tape according to claim 1.

11. An anti-shatter self-adhesive tape to prevent fragmentation or shattering of plastic components especially during an air-bag deployment, comprising, in combination:
plastic components susceptible to fragmentation or shattering during an air-bag deployment;
a first layer of a predetermined material to prevent fragmentation or shattering said plastic components; and
a second layer of high-performance pressure-sensitive adhesive laminated to said first layer to form a single-coated anti-shatter self-adhesive tape to prevent fragmentation or shattering of said plastic components especially during an air-bag deployment;
whereby the anti-shatter self-adhesive tape is applied to said plastic components to prevent fragmentation or shattering of said plastic components during an air-bag deployment.

12. An anti-shatter self-adhesive tape to prevent fragmentation or shattering of plastic components especially during an air-bag deployment according to claim 11, wherein:
said first layer comprises a woven fabric.

13. An anti-shatter self-adhesive tape to prevent fragmentation or shattering of plastic components especially during an air-bag deployment according to claim 11, wherein:
said first layer comprises a non-woven fabric.

14. An anti-shatter self-adhesive tape to prevent fragmentation or shattering of plastic components especially during an air-bag deployment according to claim 11, wherein:
said first layer comprises a plastic film.

15. An anti-shatter self-adhesive tape to prevent fragmentation or shattering of plastic components especially during an air-bag deployment according to claim 11, wherein:
said first layer comprises a reinforced plastic film.

16. An anti-shatter self-adhesive tape to prevent fragmentation or shattering of plastic components especially during an air-bag deployment according to claim 11, wherein:
said first layer comprises a woven fabric made from polyester, polyethylene, or nylon.

17. An anti-shatter self-adhesive tape to prevent fragmentation or shattering of plastic components especially during an air-bag deployment according to claim 11, wherein:
said first layer comprises a non-woven fabric made from polyester, polyethylene, or nylon.

18. An anti-shatter self-adhesive tape to prevent fragmentation or shattering of plastic components especially during an air-bag deployment according to claim 11, wherein:
said first layer comprises a plastic film made from polyester, polyethylene, or nylon.

19. An anti-shatter self-adhesive tape to prevent fragmentation or shattering of plastic components especially during an air-bag deployment according to claim 11, wherein:
said first layer comprises a reinforced plastic film made from polyester, polyethylene, or nylon.
